(19) United States
(12) Patent Application Publication
(10) Pub. No.: US 2025/0197180 A1
(43) Pub. Date: Jun. 19, 2025

(54) CARRIER SYSTEM FOR AN ELECTRICAL APPARATUS

(71) Applicant: Eaton Intelligent Power Limited, Dublin (IE)

(72) Inventors: Hua Qiang Li, Menomonee Falls, WI (US); Geraldo Nojima, Fort Mill, SC (US); Adam Krug, Menomonee Falls, WI (US); Henrique Teixeira Braga, Belo Horizonte (BR)

(21) Appl. No.: 18/540,058

(22) Filed: Dec. 14, 2023

(51) Int. Cl. B66F 9/065

(52) U.S. Cl. CPC B66F 9/065

(57) ABSTRACT

A carrier system includes: a base including a bottom side and a top side; a movement assembly attached to the bottom side, the movement assembly configured for movement in more than one direction; a carrier platform including a planar portion that extends in a two-dimensional plane, the carrier platform configured to receive and support an electrical apparatus; an adjustment apparatus attached to the base and the carrier platform, the adjustment apparatus configured to move the carrier platform relative to the base in the two-dimensional plane and in a direction that is perpendicular to the two-dimensional plane; and an operating handle attached to the base. The operating handle is configured for manual manipulation by an operator, and applying force on the operating handle moves the carrier system.

### TECHNICAL FIELD

This disclosure relates to a carrier system for an electrical apparatus.

### BACKGROUND

An electrical apparatus, such as, for example, a variable speed drive, an adjustable speed drive, or a transformer may be installed in a facility.

### SUMMARY

In one aspect, a carrier system includes: a base including a bottom side and a top side; a movement assembly attached to the bottom side, the movement assembly configured for movement in more than one direction; a carrier platform including a planar portion that extends in a two-dimensional plane, the carrier platform configured to receive and support an electrical apparatus; an adjustment apparatus attached to the base and the carrier platform, the adjustment apparatus configured to move the carrier platform relative to the base in the two-dimensional plane and in a direction that is perpendicular to the two-dimensional plane; and an operating handle attached to the base. The operating handle is configured for manual manipulation by an operator, and applying force on the operating handle moves the carrier system.

Implementations may include one or more of the following features.

The movement assembly may include a plurality of ball transfers attached to the bottom side of the base.

Applying force on the operating handle in a movement direction that is parallel to the two-dimensional plane may move the carrier system along the direction.

The carrier system also may include a power assembly configured to drive the adjustment apparatus to move the carrier platform. The carrier system also may include a control coupled to the power assembly. The control may include a user interface, and the control may be configured to drive the adjustment apparatus in response to a user input received at the user interface. The control may be configured to drive the adjustment apparatus to move in the two-dimensional plane and in the direction perpendicular to the two-dimensional plane in a manner defined by the user input. The power assembly may include one or more of an electric motor and a hydraulic system.

The carrier system also may include a locking assembly configured to hold the carrier platform in a fixed position relative to the base.

The carrier system also may include a braking assembly configured to prevent the movement assembly from moving in any direction.

The base may include a planar portion that extends parallel to the two-dimensional plane.

In another aspect, a method includes: positioning a carrier system relative to a mounting location, the carrier system including a carrier platform and a base; controlling the carrier platform to align one of two mounting sides of an electrical apparatus with a mounting location while the base is stationary; and after the one of the two mounting sides of the electrical apparatus is attached to the mounting location, controlling the carrier platform to move while the electrical apparatus is attached to the mounting location and while the base is stationary to separate the electrical apparatus from the carrier platform.

Implementations may include one or more of the following features.

The method also may include: positioning the carrier system relative to the mounting location; controlling the carrier platform to be positioned under the electrical apparatus while the base is stationary; and after the one of the two mounting sides of the electrical apparatus is detached from the mounting location, controlling the carrier platform to move away from the mounting location such that the electrical apparatus moves away from the mounting location while the base is stationary.

Controlling the carrier platform to move while the electrical apparatus is attached to the mounting location may include controlling the carrier platform to slide relative to a bottom of the electrical apparatus.

Controlling the carrier platform to align the one of the two mounting sides of the electrical apparatus with the mounting location may include controlling a height of the carrier platform until a mounting point on the one of the two mounting sides is aligned with a mounting structure on a wall.

Controlling the carrier platform to align the one of the two mounting sides of the electrical apparatus with the mounting location may include controlling a height of the carrier platform until the one of the two mounting sides is aligned with an opening of a floor-mounted cabinet, and controlling the carrier platform while the base is stationary to insert the electrical apparatus into the floor-mounted cabinet.

The one of the two mounting sides may be attached to the mounting location without using a separate hoisting mechanism.

In another aspect, a conveying system for an electrical apparatus includes: a base including a bottom side and a plurality of movement structures on the bottom side, each movement structure including a ball bearing; a support platform configured to support the electrical apparatus; an adjustment apparatus connected to the base and the support platform, the adjustment platform configured to move the support platform relative to the base to position one of two mounting sides of the electrical apparatus relative to a mounting location; and a manual operating interface attached to the base, the manual operating interface configured for manual operation by a single user and configured to transfer a force applied by the single user to the base to thereby move the conveying system.

Implementations of any of the techniques described herein may include an apparatus, a device, a carrier system, a conveying system, and/or a method. The details of one or more implementations are set forth in the accompanying drawings and the description below. Other features will be apparent from the description and drawings, and from the claims.

### DRAWING DESCRIPTION

FIGS. 1A and 1B are block diagrams of a facility and a carrier system.

FIG. 2 is a block diagram of the carrier system of FIGS. 1A and 1B on a ramp or incline.

FIG. 3A is a perspective view of another carrier system.

FIG. 3B shows a bottom side of a carrier platform of the carrier system of FIG. 3A.

FIG. 3C shows a top side of a base of the carrier system of FIG. 3A.

FIG. 3D is a side view of carrier system of FIG. 3A.

FIG. 3E is a block diagram of a movement assembly of the carrier system of FIG. 3A.

FIG. 3F shows details of an inset labeled A in FIG. 3D.

FIG. 4 is a flow chart of a process for installing an electrical apparatus.

### DETAILED DESCRIPTION

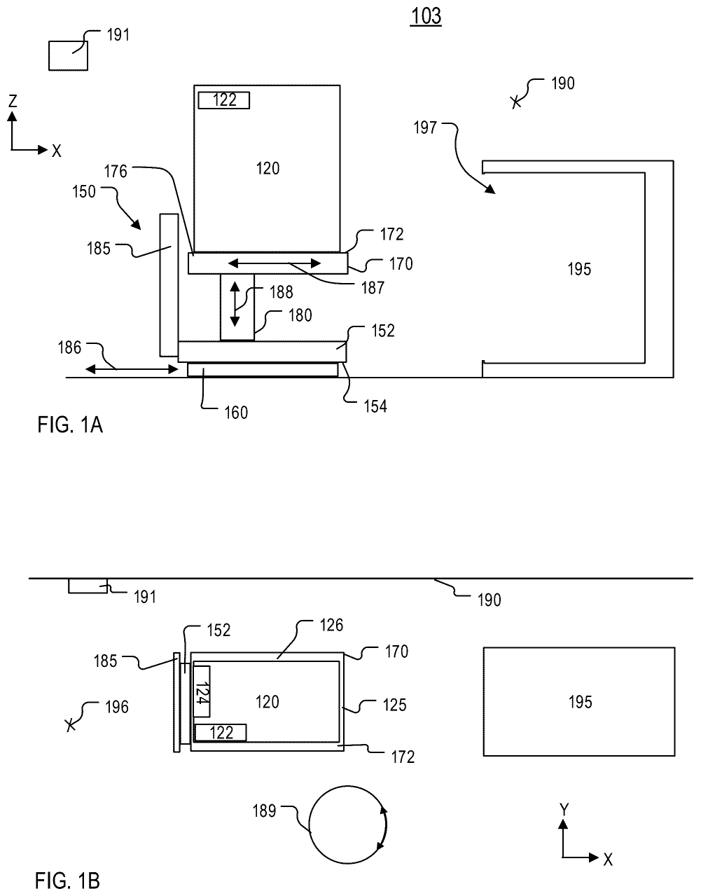

A manually operated carrier system 150 for transporting, installing, and/or removing an electrical apparatus 120 is disclosed. FIGS. 1A and 1B are block diagrams of a facility 103 that includes a working surface 196 and a wall 190. FIG. 1A is a side view of the facility 103, and FIG. 1B is a top view of the facility 103. The carrier system 150 is used to convey, carry, or transport the electrical apparatus 120 within the facility 103. The carrier system 150 is also used to install the electrical apparatus 120 on a wall mount 191 or in a floor-mounted cabinet 195 and/or to remove the electrical apparatus 120 from these or similar structures.

The electrical apparatus 120 is any type of electrical equipment that is too large, awkwardly shaped, heavy, and/or bulky for a typical person to carry and install without assistance. For example, the electrical apparatus 120 may be a transformer, power converter, switching system, recloser, switchgear, adjustable speed drive (ASD), variable speed drive (ASD), or variable frequency drive (VFD). The electrical apparatus 120 is a three-dimensional object. The dimensions of the electrical apparatus 120 may be, for example, 0.9 to 1 meters (m) high (the Z direction in FIGS. 1A and 1B) and 0.1 to 0.22 m wide (the X and Y directions in FIGS. 1A and 1B). The carrier system 150 may support up to 250 kilograms (kg) or up to 500 kg.

In the example shown, the electrical apparatus 120 has two substantially identical operating interfaces 122 and 124. The operating interfaces 122 and 124 are on different sides of the electrical apparatus 120. This configuration allows one of the operating interfaces 122, 124 to face outward from the electrical apparatus 120 regardless of which of two different mounting configurations is used for the electrical apparatus 120. The operating interfaces 122 and 124 are any type of interface that can be used to connect to the electrical apparatus 120. For example, each operating interface 122 and 124 may include a three-phase input and a three-phase output. The electrical apparatus 120 may be implemented in other ways and does not necessarily include more than one identical operating interface. Moreover, the electrical apparatus 120 may include more than two identical operating interfaces. The electrical apparatus 120 includes mounting sides 125 and 126, which are opposite the operating interfaces 122 and 124, respectively.

The facility 103 is any type of facility or site that uses and/or stores the electrical apparatus 120. For example, the facility 103 may be an industrial facility, a warehouse, a water treatment plant, a recycling plant, a waste management system, a retail operation, an office building, a hotel, or a residential building.

The carrier system 150 includes a manual operating interface 185 and is configured for manual operation by a human operator. Although the carrier system 150 may include motorized components, the carrier system 150 is not a motorized vehicle and does not include a cab or chair for the operator to ride in during operation. Instead, the motion of the carrier system 150 is controlled by force applied manually by the operator. For example, the operator may move the carrier system 150 by grasping the manual operating interface 185 and applying force to the manual operating interface 185. Furthermore, the carrier system 150 includes a movement assembly 160 that allows the carrier system 150 to move in more than one direction. The carrier system 150 is compact and can be maneuvered in a small and/or crowded facility 103.

The carrier system 150 includes a base 152, a carrier platform 170 with a receiving area 172 to hold and support the electrical apparatus 120, and an adjustment apparatus 180 that is connected to the base 152 and the carrier platform 170. The adjustment apparatus 180 is controllable to move the carrier platform 170 relative to the base 152. The adjustment apparatus 180 allows the carrier platform 170 to move independently of the base 152. In other words, the carrier platform 170 may move while the base 152 is stationary and/or may move in a different direction or at a different rate than the base 152. The adjustment apparatus 180 is controllable to move the carrier platform 170 in the +/−Z directions along a path 188 and in the +/−X directions along a path 187. The adjustment apparatus 180 also may move the carrier platform 170 in other directions in the X-Y plane. For example, the adjustment apparatus 180 may move the carrier platform 170 the +/−Y directions and/or along an arc in the X-Y plane.

The adjustment apparatus 180 is any type of mechanism or structure that is capable of moving the carrier platform 170 relative to the base 152 while the receiving area 172 is empty or while the receiving area 172 supports the electrical apparatus 120. The adjustment apparatus 180 may include, for example, mechanical linkages, pneumatic linkages, gears, plates, plungers, articulating joints, support arms, support legs, pivot points, connectors, sliders, channels, or a combination of such devices.

The adjustment apparatus 180 is attached to the carrier platform 170 and the base 152 such that changes in the size, position, and/or shape of the adjustment apparatus 180 cause the carrier platform 170 to move relative to the base 152. For example, the adjustment apparatus 180 may be configured to expand and contract along the Z direction and to slide along the X and Y directions. In this example, when the adjustment apparatus 180 expands in the Z direction, the carrier platform 170 moves away from the base 152 in the Z direction, and when the adjustment apparatus 180 contracts in the −Z direction, the carrier platform 170 moves in the −Z direction toward the base 152.

The carrier system 150 also includes the movement assembly 160 on a bottom side 154 of the base 152. The movement assembly 160 allows the carrier system 150 to move in any direction on the working surface 196. For example, the movement assembly 160 allows the carrier system 150 to move linearly in the X-Y plane (for example, along a path 186) and/or along a clockwise or counterclockwise arc or circle in the X-Y plane (for example, along the path 189).

The movement assembly 160 includes one or more elements that contact the working surface 196 and allow the carrier system 150 to move along the working surface 196. For example, the movement assembly 160 may include one or more wheels or ball bearings, each of which is able to rotate relative to a mounting feature that is attached to the bottom side 154 of the base 152. The movement assembly 160 may include one or more ball transfers that are attached to the bottom side 154. Other mechanisms may be used in the movement assembly 160. Moreover, the movement assembly 160 may include mechanisms that do not rotate. For example, the movement assembly 160 may include one or more pads that are configured to slide on the working surface 196.

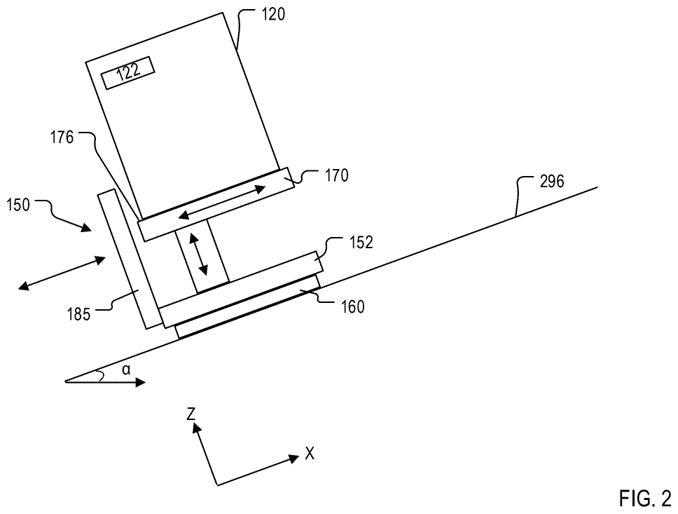

The working surface 196 is any type of relatively smooth surface in the facility 103. Examples of the working surface 196 include a floor, a stage, or a platform. The working surface 196 is illustrated as being horizontal in FIGS. 1A and 1B, but the working surface 196 may be inclined and the carrier system 150 may be maneuvered on a non-horizontal surface. For example, the carrier system 150 may be maneuvered on a ramp 296 that is at an angle alpha (α) relative to the horizontal, as shown in FIG. 2.

The carrier system 150 may include additional features. For example, the carrier system 150 may include a locking element or braking element that is configured to hold the movement assembly 160 and to prevent movement of the carrier system 150. The locking element or braking element may be configured to be set or controlled by the operator. Holding the carrier system 150 in place may facilitate safe and easy placement of the electrical apparatus 120 in the receiving area 172. Furthermore, the locking element or braking element allows the carrier system 150 to be held in place while unattended. The carrier system 150 also may include a locking device that is operable to hold the carrier platform 170 in a fixed position relative to the base 152.

In another example, the carrier platform 170 may include one or more elements or features configured to hold the electrical apparatus 120 in place in the receiving area 172 such that the electrical apparatus 120 does not move relative to the carrier platform in an unexpected or unintentional manner. For example, the receiving area 172 may include a bracket or stopper at an edge 176. The bracket or stopper may extend in the Z direction and may be in contact with the electrical apparatus 120. The bracket or stopper acts to prevent the electrical apparatus 120 from sliding in the −X direction and promotes safe operation of the carrier system 150.

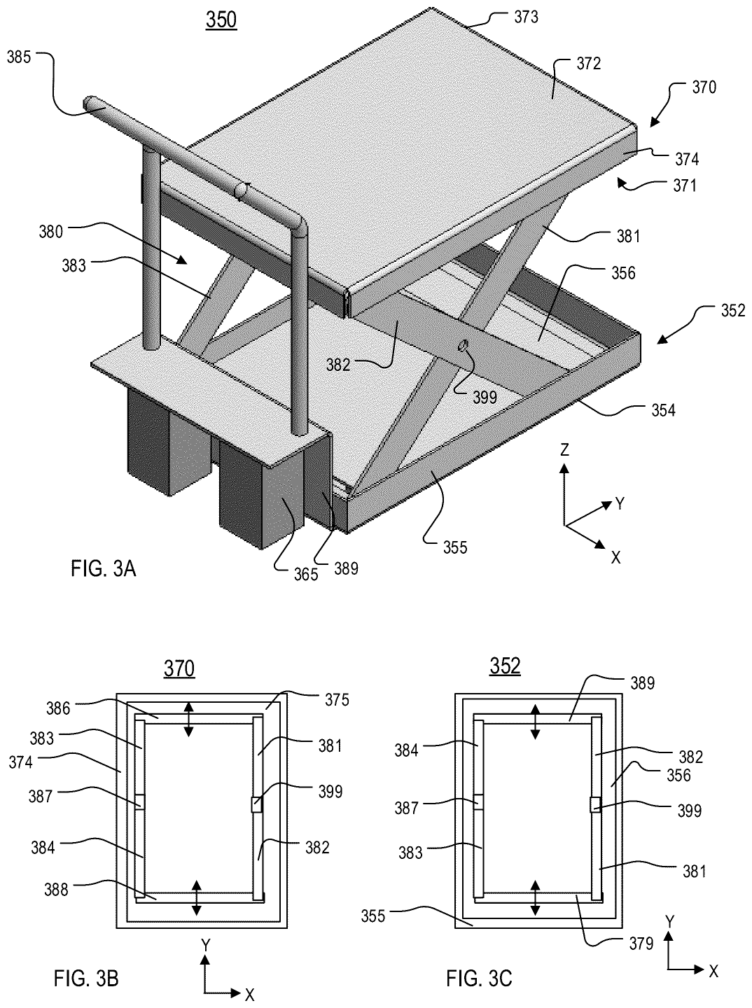

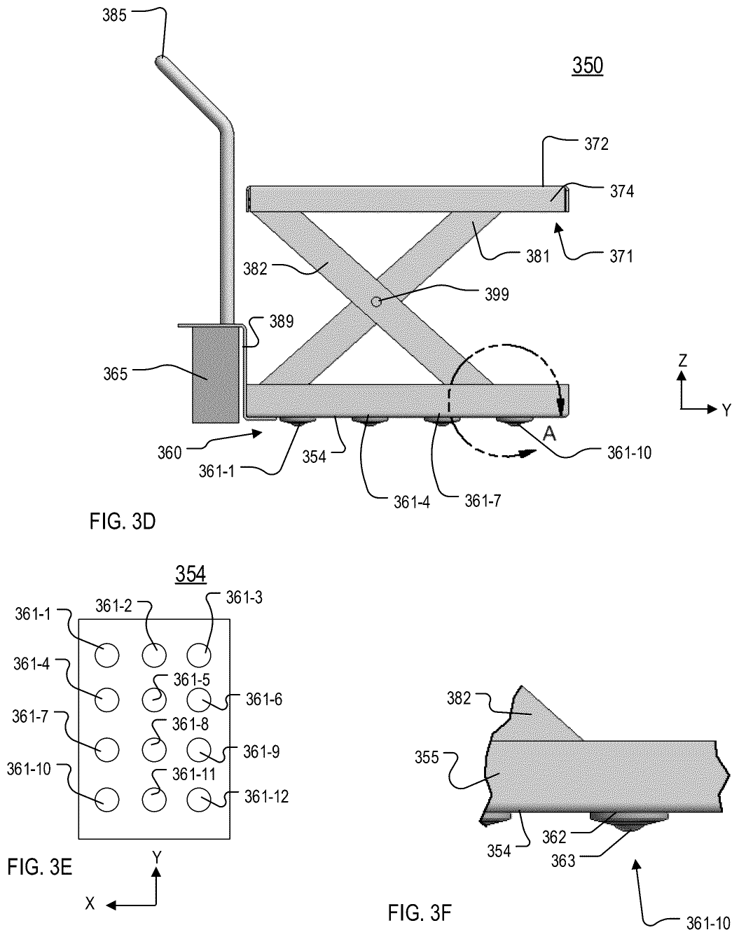

FIG. 3A is a perspective view of another carrier system 350. The carrier system 350 includes a base 352 and a carrier platform 370. The carrier platform 370 includes a receiving area 372 that is configured to hold and support an electrical apparatus (such as the electrical apparatus 120 of FIGS. 1A and 1B). The receiving area 372 is planar. The receiving area 372 has an area in the X-Y plane that is the same or slightly larger than the area of the electrical apparatus in the X-Y plane. This allows the receiving area 372 to accommodate and support the electrical apparatus while also minimizing the size of the carrier system 350.

The carrier platform 370 has a perimeter 373 that is level with the receiving area 372 or is beveled. The perimeter 373 does not include a feature (such as a lip or flange) that extends in the Z direction. This configuration allows the electrical apparatus to be slid onto and off of the receiving area 372. The carrier platform 370 includes edges 374 that extend from the receiving area 372 in the −Z direction. Referring also to FIG. 3B, the edges 374 define an underside region 375 on a bottom side 371 of the carrier platform 370.

The base 352 includes a perimeter side 355 that extends in the Z direction and defines a top base region 356. The base 352 provides additional support to the carrier system 350. The top base region 356 is planar and generally flat. The base 352 is parallel to the carrier platform 370, with the top base region 356 facing the underside region 375. The carrier system 350 also includes an adjustment assembly 380 between the base 352 and the carrier platform 370. The carrier platform 370 is separated from the base 352 in the Z direction by a distance that is controlled by the adjustment assembly 380.

The adjustment assembly 380 is a foldable frame that includes legs 381, 382, 383, 384. The adjustment assembly 380 also includes top frame bars 386, 388 and lower frame bars 389, 379. The frame bars 386 and 388 can move along the Z axis relative to the underside region 375. The frame bars 386 and 388 may be attached to the underside region 375 with, for example, a track (not shown) that is mounted to the interior side of the edges 374. The lower frame bars 389, 379 are in the top base region 356 (FIG. 3C) and can move along the Z axis relative to the top base region 356.

One end of each leg 381, 383 is attached to the frame bar 386 and the opposite end of each leg 381, 383 is attached to the frame bar 379. One end of each leg 382, 384 is attached to the frame bar 388 and the opposite end of each leg 382, 384 is attached to the frame bar 389. The legs 381, 382 are attached to each other at a pivot point 399 and can rotate relative to each other about the pivot point 399. The legs 382, 384 are attached to each other at a pivot point 387 and can rotate relative to each other about the pivot point 387.

Moving the frame bars 386, 388, 389 and/or 379 along the Y axis changes the shape and/or position of the adjustment assembly 380. For example, moving the frame bars 388 and 379 in the Z direction while keeping the frame bars 386 and 389 in a fixed position increases the distance between the carrier platform 370 and the base 352. Moving all of the frame bars 386, 388, 379, and 389 in the Y direction moves the carrier platform 370 in the Y direction while the base 352 does not move. In this way, adjusting one or more of the frame bars 386, 388, 379, and 389 and/or the legs 381, 382, 383, 384 adjusts the position of the carrier platform 370 relative to the base 352.

The adjustment assembly 380 may be implemented in other ways. For example, the adjustment assembly 380 may be implemented as a scissor-lifting mechanism. In the scissor-lifting mechanism, the legs 381 and 382 are rotated about the pivot point 399 relative to each other like scissor blades, and the legs 383 and 384 rotate about the pivot point 387 relative to each other like scissor blades. With the scissor-lifting mechanism the operator may elongate or contract the legs 381, 382, 383, 384, moving the adjustment assembly 380 only in the Z axis, keeping the platform 370 stable and parallel to the base 352.

The adjustment assembly 380, the base 352, and the platform 370 are made of a rugged and strong material. Examples of materials that may be used for these and/or other components of the carrier system 350 include, without limitation, various types of steel, such as carbon steel, alloy steel, and cold-rolled steel. Cold-rolled steel has a greater tensile strength than steel that is not cold-rolled. Using cold-rolled steel for the carrier system 350 may increase the load-bearing capacity of the system 350.

The carrier system 350 also includes a driving unit 365 that is coupled to the adjustment assembly 380. The driving unit 365 is used to change the configuration of the adjustment assembly 380 to thereby change the position of the carrier platform 370. The driving unit 365 may include, for example, an electric motor and associated components for powering and controlling the motor, and a user interface to allow the operator to control the driving unit 386 and the adjustment apparatus 380. The driving unit 365 may be coupled to the adjustment assembly 380 with, for example, one or more shafts and/or gears. The driving unit 365 also may be configured to hold the adjustment assembly 380 when there is no intentional change to the configuration of the adjustment assembly 380.

Referring also to FIG. 3D, which is a side view of carrier system 350, the base 352 has a bottom side 354 that is opposite the top base region 356. A movement assembly 360 is attached to the bottom side 354. Referring also to FIG. 3E, which shows the bottom side 354, the movement assembly 360 includes twelve ball transfers 361-1 to 361-12 (collectively referred to as the ball transfers 361) arranged in a grid on the bottom side 354. FIG. 3F shows details of an inset labeled A in FIG. 3D. The inset includes the ball transfer 361-10. The ball transfer 361-10 includes an omnidirectional load-bearing spherical ball 363 mounted inside a restraining fixture or housing 362. The housing 362 is fixedly mounted to the bottom side 354. The ball 363 extends out of the housing 362 and can rotate in any direction. The other ball transfers are identical to the ball transfer 361-10.

In operational use of the carrier system 350, the ball 363 makes contact with the working surface (for example, the surface 196 of FIGS. 1A and 1B). When the ball 363 rotates, the carrier system 350 rolls along the working surface. Because the ball transfers 361 are omnidirectional, the carrier system 350 may be moved and steered in any direction. Having the grid of ball transfers 361 increases the stability and usability of the carrier system 350 and also increases the amount of weight that the carrier system 350 is able to support and convey. The carrier system 350 may be implemented with fewer than twelve ball transfers or more than twelve ball transfers.

The carrier system 350 also includes a manual operating interface 385. In the example shown, the manual operating interface 385 is a handle that is configured to be grasped by one or both hands of a human operator. The manual operating interface 385 is mechanically coupled to the base 352. In the carrier 350, the manual operating interface 385 is attached to a bracket 398, which is attached to the base 352. The bracket 398 may be used to protect the driving unit 365 from collisions with that fall from the receiving area 372. In this way, the bracket provides protection to the driving unit 365 and electronic components that may be in the driving unit 365.

In other implementations, the manual operating interface 385 may be directly attached to the base 352. When the human operator applies a force to the manual operating interface 385, the force is transferred to the base 352, the balls 363 of the ball transfers 361 rotate and the carrier system 350 moves. For example, if the operator walks and pushes the operating handle while walking, the carrier system 350 also moves in the direction in which the operator is walking.

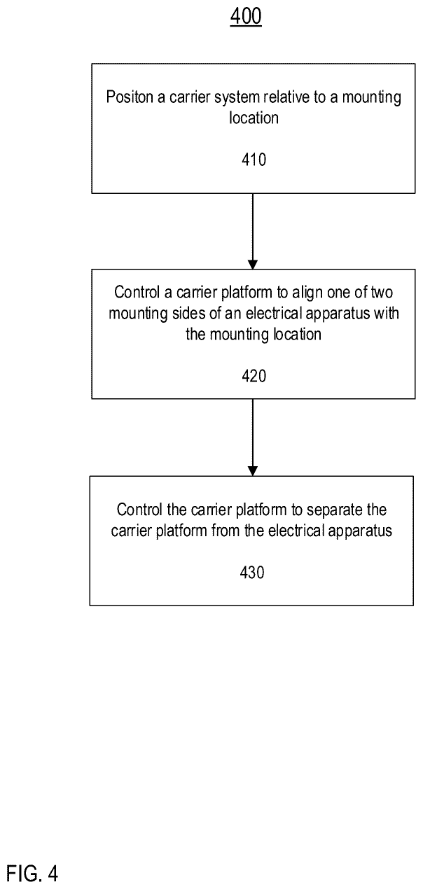

FIG. 4 is a flow chart of a process 400 for installing an electrical apparatus. The process 400 is discussed with respect to installing the electrical apparatus 120 using the carrier system 150 shown in FIGS. 1A and 1B. However, the process 400 also may be used to install other electrical apparatuses. Moreover, the carrier system 350 may be used to perform the process 400.

The carrier system 150 is positioned relative to a mounting location (410). The mounting location may be, for example, the cabinet 195 or the wall mount 191. To position the carrier system 150 near the mounting location, the operator applies force to the manual operating interface 185 in the direction in which the carrier system 150 is to be moved. For example, to move the carrier system 150 to the cabinet 195, the operator pushes the manual operating interface 185 in the X direction to move the carrier system 150 toward the cabinet 195. To move the carrier system 150 to the wall mount 191, the operator applies force to the carrier system 150 such that the carrier system 150 moves in the Y and −X directions.

The carrier platform 170 is controlled to align one of two mounting sides 125, 126 of the electrical apparatus 120 with the mounting location (420). The operator also positions the carrier system 150 such that the electrical apparatus 120 is oriented properly for the mounting location. For example, to prepare to install the electrical apparatus 120 in the cabinet 195, the carrier system 150 is moved toward a cabinet opening 197. The carrier system 150 positioned such that the mounting side 125 faces the cabinet opening 197 and the operating interface 122 faces out of the cabinet 197. Once the carrier system 150 is positioned at the cabinet opening 197, the adjustment apparatus 180 is controlled to move the carrier platform 170 in the −Z direction until the electrical apparatus 120 is aligned with the cabinet opening 197. The adjustment apparatus 180 is controlled to move in the X direction, which causes the carrier platform 170 to move in the X direction and moves the electrical apparatus 120 into the cabinet 195. After being positioned in the cabinet 195, the electrical apparatus 120 is secured in the cabinet 195. To secure the electrical apparatus 120 in the cabinet 195, fixing holes or other features on the electrical apparatus 120 are mounted to corresponding brackets inside the cabinet 195.

To prepare to install the electrical apparatus 120 on the wall mount 191, the carrier system 150 is positioned near the wall mount 191 with the mounting side 126 of the electrical apparatus 120 facing the wall 190 that holds the wall mount 191. The adjustment apparatus 180 is controlled to expand in the Z direction and the carrier platform 170 also moves in the Z direction until the mounting side 126 is aligned with the wall mount 191. The operator mounts the mounting side 126 to the wall mount 191. The ability to control the positioning of the electrical apparatus 120 by controlling the position of the carrier system 150 and the carrier platform 170 allows the electrical apparatus 120 to be mounted in the cabinet 195 or on the wall mount 191 by a single person without using external devices, such as, for example, a hoist, crane, and/or a forklift.

The carrier platform 170 is moved to separate the carrier platform 170 from the electrical apparatus 120 (430). For example, after the electrical apparatus 120 is secured in the cabinet, the carrier platform 170 is slid in the −X direction by controlling the adjustment apparatus 180. The electrical apparatus 120 remains secured in the cabinet 195, and the carrier platform 170 slides out of the cabinet without the electrical apparatus 120. After the electrical apparatus 120 is attached to the wall mount 191, the adjustment apparatus 180 is controlled to move in the −Z direction such that the carrier platform 170 also moves in the −Z direction. The electrical apparatus 120 remains attached to the wall mount 191 and the carrier platform 170 separates from the electrical apparatus 120.

The carrier system 150 also may be used to remove the electrical apparatus 120. For example, the adjustment apparatus 180 may be controlled to place the carrier platform 170 under the electrical apparatus 120 while the electrical apparatus 120 is attached to the wall mount 191. The electrical apparatus 120 is separated from the wall mount 191 and its full weight rests on the carrier platform 170. The adjustment apparatus 180 is controlled again to move the carrier platform 170 (with the electrical apparatus 120) in the −Z direction.

These and other implementations are within the scope of the claims.

What is claimed is:

1. A carrier system comprising:
a base comprising a bottom side and a top side;
a movement assembly attached to the bottom side, the movement assembly configured for movement in more than one direction;
a carrier platform comprising a planar portion that extends in a two-dimensional plane, the carrier platform configured to receive and support an electrical apparatus;
an adjustment apparatus attached to the base and the carrier platform, the adjustment apparatus configured to move the carrier platform relative to the base in the two-dimensional plane and in a direction that is perpendicular to the two-dimensional plane; and
an operating handle attached to the base, wherein, the operating handle is configured for manual manipulation by an operator, and applying force on the operating handle moves the carrier system.

2. The carrier system of claim 1, wherein the movement assembly comprises a plurality of ball transfers attached to the bottom side of the base.

3. The carrier system of claim 1, wherein applying force on the operating handle in a movement direction that is parallel to the two-dimensional plane moves the carrier system along the movement direction.

4. The carrier system of claim 1, further comprising a power assembly configured to drive the adjustment apparatus to move the carrier platform.

5. The carrier system of claim 4, further comprising a control coupled to the power assembly, the control comprising a user interface, and wherein the control is configured to drive the adjustment apparatus in response to a user input received at the user interface.

6. The carrier system of claim 5, wherein the control is configured to drive the adjustment apparatus to move in the two-dimensional plane and in the direction perpendicular to the two-dimensional plane in a manner defined by the user input.

7. The carrier system of claim 4, wherein the power assembly comprises one or more of an electric motor and a hydraulic system.

8. The carrier system of claim 1, further comprising a locking assembly configured to hold the carrier platform in a fixed position relative to the base.

9. The carrier system of claim 1, further comprising a braking assembly configured to prevent the movement assembly from moving in any direction.

10. The carrier system of claim 1, wherein the base comprises a planar portion that extends parallel to the two-dimensional plane.

11. A method comprising:
positioning a carrier system relative to a mounting location, the carrier system comprising a carrier platform and a base;
controlling the carrier platform to align one of two mounting sides of an electrical apparatus with a mounting location while the base is stationary; and
after the one of the two mounting sides of the electrical apparatus is attached to the mounting location, controlling the carrier platform to move while the electrical apparatus is attached to the mounting location and while the base is stationary to separate the electrical apparatus from the carrier platform.

12. The method of claim 11, further comprising:
positioning the carrier system relative to the mounting location;
controlling the carrier platform to be positioned under the electrical apparatus while the base is stationary; and
after the one of the two mounting sides of the electrical apparatus is detached from the mounting location, controlling the carrier platform to move away from the mounting location such that the electrical apparatus moves away from the mounting location while the base is stationary.

13. The method of claim 11, wherein controlling the carrier platform to move while the electrical apparatus is attached to the mounting location comprises controlling the carrier platform to slide relative to a bottom of the electrical apparatus.

14. The method of claim 11, wherein controlling the carrier platform to align the one of the two mounting sides of the electrical apparatus with the mounting location comprises controlling a height of the carrier platform until a mounting point on the one of the two mounting sides is aligned with a mounting structure on a wall.

15. The method of claim 11, wherein controlling the carrier platform to align the one of the two mounting sides of the electrical apparatus with the mounting location comprises controlling a height of the carrier platform until the one of the two mounting sides is aligned with an opening of a floor-mounted cabinet, and controlling the carrier platform while the base is stationary to insert the electrical apparatus into the floor-mounted cabinet.

16. The method of claim 11, further comprising attaching the one of the two mounting sides to the mounting location without using a separate hoisting mechanism.

17. A conveying system for an electrical apparatus, the conveying system comprising:
a base comprising a bottom side and a plurality of movement structures on the bottom side, each movement structure comprising a ball bearing;
a support platform configured to support the electrical apparatus;
an adjustment apparatus connected to the base and the support platform, the adjustment platform configured to move the support platform relative to the base to position one of two mounting sides of the electrical apparatus relative to a mounting location; and
a manual operating interface attached to the base, the manual operating interface configured for manual operation by a single user and configured to transfer a force applied by the single user to the base to thereby move the conveying system.
